(19) United States
(12) Patent Application Publication
(10) Pub. No.: US 2013/0297462 A1
(43) Pub. Date: Nov. 7, 2013

(54) SPARE PARTS ON-HAND INVENTORY MANAGEMENT

(71) Applicant: Damian Antonio Ottley, Irving, TX (US)

(72) Inventor: Damian Antonio Ottley, Irving, TX (US)

(73) Assignee: Verizon Patent and Licensing Inc., Basking Ridge, NJ (US)

(21) Appl. No.: 13/465,234

(22) Filed: May 7, 2012

(51) Int. Cl. G06Q 10/08

(52) U.S. Cl. 705/28

(57) ABSTRACT

An inventory management device defines risk factors for multiple parts, in which each of the risk factors correspond to a time required for a failed one of the multiple parts to be replaced. The inventory management device determines reliability data associated with the multiple parts, and determines a number of spares of each of the multiple parts to add to each of multiple inventory locations based on the multiple parts' reliability data and defined risk factors.

### BACKGROUND

Installation, repair and maintenance of equipment and/or systems may necessitate the availability and use of a large quantity of parts that are used in the equipment and/or systems. Therefore, to install, repair or maintain equipment and/or systems in a timely manner, a large inventory of replacement parts may have to be maintained on-hand. Without maintaining such a large inventory of replacement parts, equipment and/or systems can fail, or be non-operational, for extended periods of time until the replacement parts can be procured. For example, in a venture that utilizes equipment and/or systems on a large scale, management of the replacement parts inventory can be a burdensome endeavor that, if not performed properly, can result in extended periods of “downtime” for certain equipment and/or systems that are waiting on the procurement of replacement parts that are not available on-hand. Such extended periods of “downtime” can have a significant negative impact on services (e.g., telecommunication services, etc.) provided by the venture that uses the failed equipment and/or systems and, thus, can result in substantial revenue losses.

### BRIEF DESCRIPTION OF THE DRAWINGS

FIG. 1 is a diagram that illustrates an exemplary parts inventory management process for maintaining sufficient spare parts on-hand at multiple different parts storage and inventory locations such that the parts can be made available for system/equipment maintenance and repair;

FIG. 2 is a diagram that depicts an exemplary network environment in which the spare on-hand procurement processes of FIG. 1 may be implemented;

FIG. 3 is a diagram that depicts exemplary components of the inventory management device of FIGS. 1 and 2;

FIG. 4 is a diagram that depicts an exemplary data structure that may be stored in the parts data database of FIG. 2;

FIG. 5 is a diagram that depicts an exemplary data structure that may be stored in the parts inventory database of FIG. 2;

FIG. 6 is a diagram that depicts an exemplary spares on-hand procurement process of FIG. 1;

FIG. 7 is a flow diagram that illustrates the part standardization process of FIG. 6;

FIG. 8 is a diagram associated with the exemplary process of FIG. 7;

FIGS. 9A and 9B are flow diagrams that illustrate the actual Mean Time Between Failure determination process of FIG. 6;

FIGS. 10A and 10B are diagrams associated with the exemplary process of FIGS. 9A and 9B;

FIGS. 11A and 11B are flow diagrams that illustrate the spare parts on-hand process of FIG. 6;

FIGS. 12A and 12B are diagrams associated with the exemplary process of FIGS. 11A and 11B;

FIG. 13 is a flow diagram that illustrates the spare parts ordering process of FIG. 6;

FIG. 14 is a diagram associated with the exemplary process of FIG. 13; and

FIG. 15 is a diagram of a Spares Poisson Distribution Nomograph that can be used to determine a number of spares S to keep in stock.

### DETAILED DESCRIPTION OF THE PREFERRED EMBODIMENTS

The following detailed description refers to the accompanying drawings. The same reference numbers in different drawings may identify the same or similar elements. The following detailed description does not limit the invention.

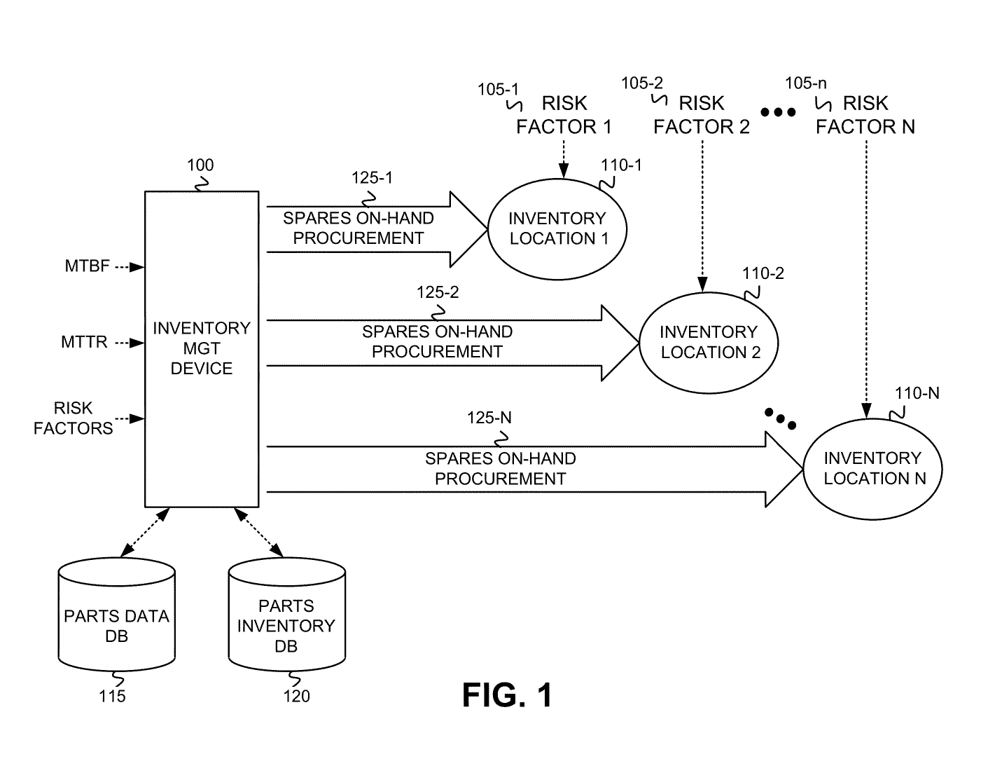

FIG. 1 illustrates an exemplary overview of processes for maintaining sufficient spare parts on-hand at multiple different parts storage and inventory locations such that the parts can be made available for system/equipment maintenance and repair. A “part,” as referred to herein, may include a part or component of a larger piece of equipment, subsystem or system, or an item of equipment that is part of a larger item of equipment, a subsystem, or a system. Thus, a “part” as referred to herein may include any type of distinct part, component, or piece of equipment that may be maintained in inventory for installing, repairing or maintaining a larger piece of equipment, a subsystem or a system. As shown in FIG. 1, an inventory management device 100 may receive reliability data associated with the reliability of parts in inventory, including Mean Time Between Failure (MTBF) values, and Mean Time to Repair (MTTR) values. Inventory management device 100 may additionally receive risk factors 105-1 through 105-N (where N is any integer greater than one) associated with each different part. These risk factors may include maintenance spare risk level indicators that define the time required for a failed part to be replaced in order to avoid a “reportable” outage condition (e.g., a system or equipment “down” condition). Thus, risk factors 105-1 through 105-N provide some measure, or indication, or the critical or non-critical nature of a specific part, and how quickly the part needs to be obtained to enable timely system/equipment installation, maintenance or repair.

In one implementation, the risk factors may be divided into three different risk factors, with a risk factor of 1 including parts the failure of which could result in major outages or major downtime for critical systems/equipment. Parts having a risk factor of 1, therefore, need to be available within a narrow window of time (e.g., a single hour) and, therefore, must have an inventory location in relatively close proximity to the site where maintenance and/or repair is being performed. For example, parts having a risk factor of 1 may be stored at the part/equipment installation site. The three different risk factors may further include a risk factor of 2 that includes parts that need to be available for maintaining or repairing systems or equipment identified as non-critical or redundant. Parts with a risk factor of 2 may need to be made available, for example, within a 24 hour period. Parts with a risk factor of 2 must have an inventory location within a reasonable distance of the maintenance/repair/installation site such that the part can reach the maintenance/repair/installation site within the 24 hour period. For example, parts with a risk factor of 2 may be stored in a warehouse within a relatively short distance from the maintenance/repair/installation site.

The three different risk factors may also include a risk factor of 3 that includes parts that do not affect the installation, repair or maintenance of a system or equipment. Parts with a risk factor of 3, therefore, do not need to be quickly available. The inventory location may include, for example, a remote warehouse, or a warehouse associated with the part manufacturer/vendor itself According to other implementations, different risk factors and different inventory locations, than those described above may be used. Each risk factor can be associated with a time period during which the part is needed to be available for installation, maintenance or repair. Critical parts may be associated with risk factors having a short time period, and non-critical parts may be associated with risk factors having longer time periods.

As shown in FIG. 1, each of risk factors 105-1 through 105-N is associated with a respective inventory location 110-1 through 110-N. For each part identified in a parts database (DB) 115, inventory management device 100 may retrieve parts inventory data from a parts inventory DB 120, and based on the risk factor associated with each part, and each part's MTBF, MTTR and parts inventory data, may perform spares on-hand procurement processes 125-1 through 125-N, as described further below, to obtain an appropriate number of spares of each part at each inventory location 110-1 through 110-N.

Performance of the spares on-hand procurement processes 125-1 through 125-N may attempt to ensure that an adequate number of spares of each part is present at each of inventory locations 110-1 through 110-N based on the risk factor associated with each part. The spares on-hand procurement processes 125-1 through 125-N maintain a minimum supply of spares at each inventor location 110 to ensure that adequate spares are always on-hand, and that the installation, maintenance and repair of systems/equipment can be performed without unnecessary delays, waiting on parts that are out of stock, and/or temporary unavailable.

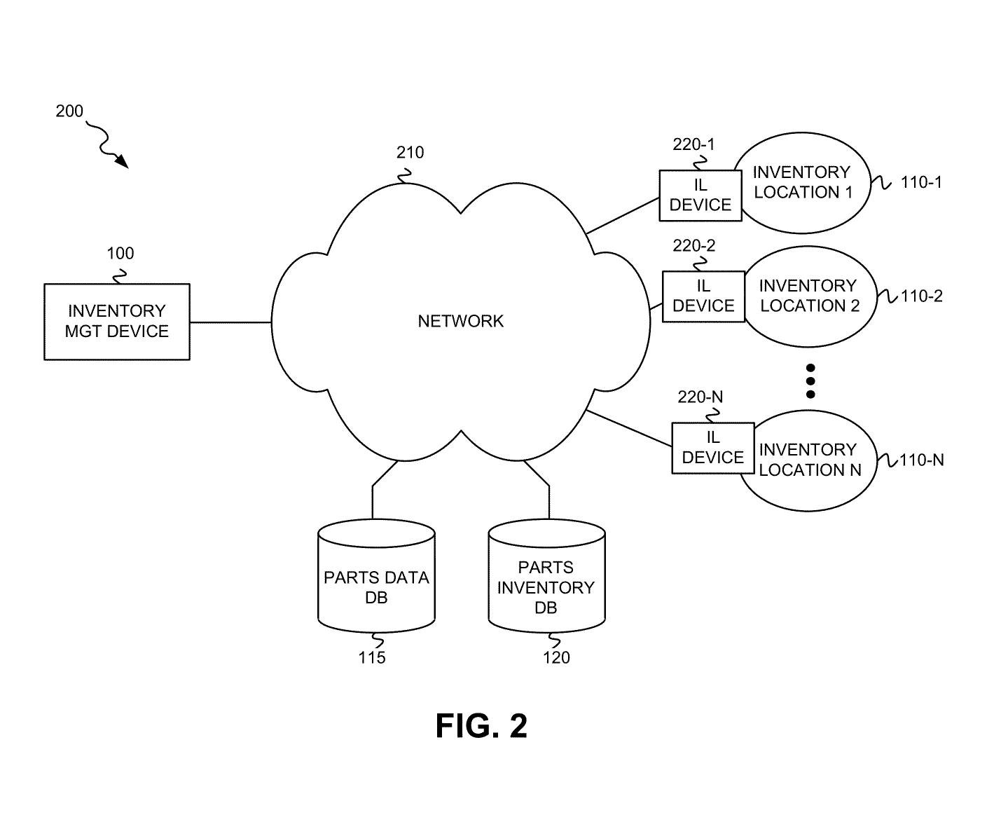

FIG. 2 is a diagram that depicts an exemplary network environment 200 in which spares on-hand procurement processes 125 of FIG. 1 may be implemented to ensure sufficient spare parts are stored at each of inventory locations 105-1 through 105-N. Network environment 200 may include inventory management device 100, parts data database (DB) 115, parts inventory database (DB) 120, network 210, and inventory location (IL) devices 220-1 through 220-N.

As described above with respect to FIG. 1, inventory management device 100 may perform spares on-hand procurement processes 125 to obtain a determined number of spares of each part at each of inventory locations 110-1 through 110-N.

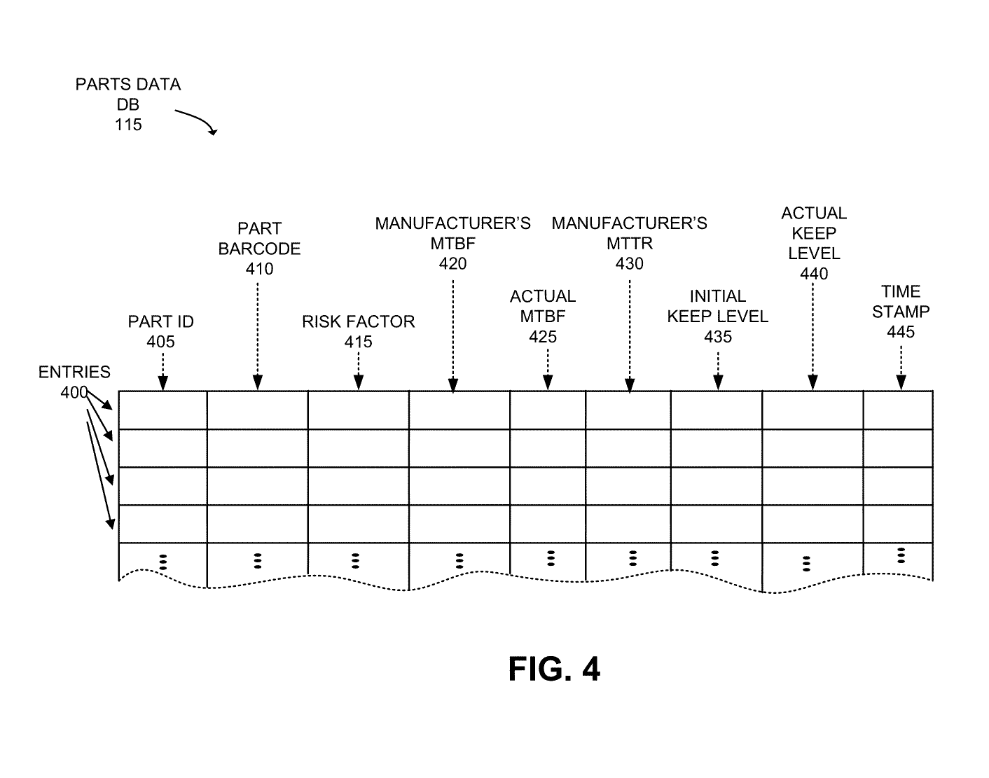

Parts data DB 115 stores a data structure that includes various items of data about each part maintained in inventory at inventory locations 110-1 through 110-N, or other parts not maintained in inventory. The various items of data stored in parts data DB 115 include the risk factor of each part, and reliability data associated with each part. The various items of data stored in parts data DB 115 are further described with respect to FIG. 4.

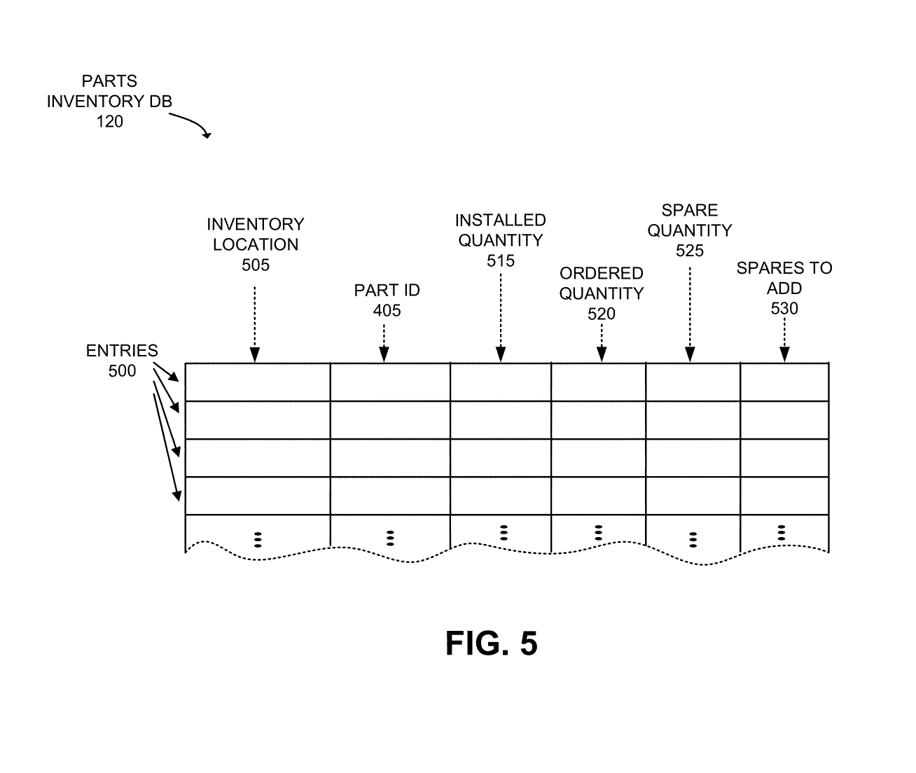

Parts inventory DB 120 stores a data structure that includes various items of data related to the inventory of each part at each of inventory locations 110-1 through 110-N. The various items of data stored in parts inventory DB 120 are further described with respect to FIG. 5.

IL devices 220-1 through 220-N each reside at a respective one of inventory locations 110-1 through 110-N, and interconnect the respective inventory location 110 to network 210. IL devices 220-1 through 220-N may receive scanned barcode information associated with parts installed from inventory maintained at a respective inventory location 110, and may receive scanned barcode information associated with ordered parts at a respective inventory location 110. IL devices 220-1 through 220-N may send the scanned barcode information to inventory management device 100, or to parts inventory DB 120, via network 210.

Network 210 may include one or more networks of various types. For example, network 210 may include a cable network (e.g., an optical cable network), a satellite network, a wireless public land mobile network (PLMN) (e.g., a Code Division Multiple Access (CDMA) 2000 PLMN, a Global System for Mobile Communications (GSM) PLMN, a Long Term Evolution (LTE) PLMN and/or other types of PLMNs), a telecommunications network (e.g., a Public Switched Telephone Network (PSTN)), a local area network (LAN), a wide area network (WAN), a metropolitan area network (MAN), an intranet, and/or the Internet.

The configuration of network components of network environment 200 illustrated in FIG. 2 is for illustrative purposes. Other configurations may be implemented. Therefore, network environment 200 may include additional, fewer and/or different components than those depicted in FIG. 2.

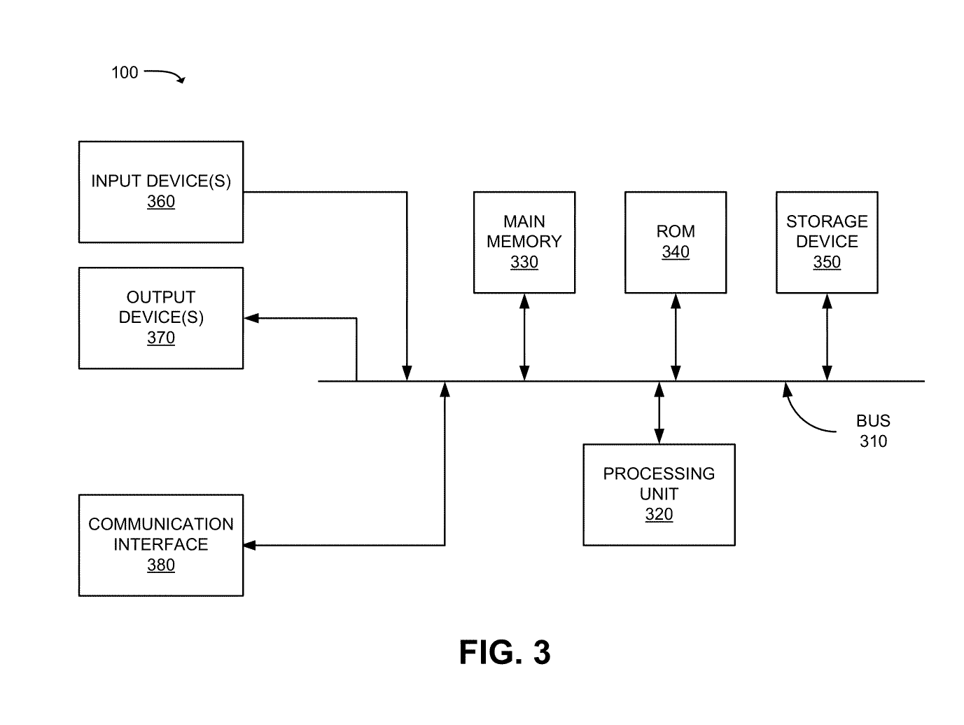

FIG. 3 is a diagram that depicts exemplary components of inventory management device 100. IL devices 220-1 through 220-N, a device that stores parts data DB 115, and a device that stores parts inventory DB 120 may be similarly configured. Inventory management device 100 may include a bus 310, a processing unit 320, a main memory 330, a read only memory (ROM) 340, a storage device 350, an input device(s) 360, an output device(s) 370, and a communication interface(s) 380. Bus 310 may include a path that permits communication among the components of device 100.

Processing unit 320 may include one or more processors or microprocessors, or processing logic, which may interpret and execute instructions. Main memory 330 may include a random access memory (RAM) or another type of dynamic storage device that may store information and instructions for execution by processing unit 320. ROM 340 may include a ROM device or another type of static storage device that may store static information and instructions for use by processing unit 320. Storage device 350 may include a magnetic and/or optical recording medium. Main memory 330, ROM 340 and storage device 350 may each be referred to herein as a “computer-readable medium.”

Input device 360 may include one or more mechanisms that permit an operator to input information to inventory management device 100, such as, for example, a keypad or a keyboard, a display with a touch sensitive panel, voice recognition and/or biometric mechanisms, etc. Output device 370 may include one or more mechanisms that output information to the operator, including a display, a speaker, etc. Communication interface(s) 380 may include a transceiver that enables server device 100 to communicate with other devices and/or systems. For example, communication interface(s) 380 may include wired or wireless transceivers for communicating via network 210.

The configuration of components of inventory management device 100 illustrated in FIG. 3 is for illustrative purposes. Other configurations may be implemented. Therefore, inventory management device 100 may include additional, fewer and/or different components than those depicted in FIG. 3.

FIG. 4 is a diagram that depicts a data structure that may be stored in parts data DB 115. Part data DB 115 may include multiple entries 400, with each entry 400 further including a part identifier (ID) field 405, a part barcode field 410, a risk factor field 415, a manufacturer's MTBF field 420, an actual MTBF field 425, a manufacturer's MTTR field 430, an initial keep level field 435, an actual keep level field 440, and a time stamp field 445.

Part ID field 405 stores a unique identifier for a given part. Part barcode field 410 stores barcode information assigned to the part identified by part ID field 405. Risk factor field 415 stores a risk level indicator that defines the time required for the part identified by part ID field 405 to be replaced in order to avoid a lengthy outage condition (e.g., a system or an equipment “down” condition). The risk level indicator stored in risk factor field 415 provides a measure of the critical or non-critical nature of the part identified by part ID field 405, and how quickly the part needs to be obtained to enable timely system/equipment installation, maintenance or repair.

Manufacturer's MTBF value 420 stores the Mean Time Between Failure (MTBF) value, for the part identified by part ID 405, obtained from the manufacturer of the part (or from other official sources). The MTBF value describes the average time to failure of the part, and is equal to the inverse of the failure rate of the part (i.e., MTBF=1/failure rate), in which the failure rate consists of a number of failures of the part during a given period of time. The MTBF of a given part can typically be obtained from the manufacturer of the part, or from other industry sources. Alternatively, or in addition to the manufacturer's MTBF value, field 420 may store a Failure in Time (FIT) value for the part identified by part ID 405. The FIT value equals the total number of failures of the part in a billion hours.

Actual MTBF value field 425 stores the MTBF value obtained from analyzing the actual failure rate of the part identified by part ID 405. Failures of the part over time may be analyzed to determine the actual, observed MTBF, as opposed to the theoretical MTBF obtained from the part manufacturer or vendor. Manufacturer's MTTR 430 stores the Mean Time to Repair (MTTR) value, for the part identified by part ID 405, obtained from the manufacturer of the part (or from other official sources). The MTTR value describes the average time required to repair the failed part. The MTTR value may be defined as the total corrective maintenance time divided by the total number of corrective maintenance actions during a given period of time.

Initial keep level field 435 stores a value that defines a quantity of spare parts to keep for a certain quantity of parts installed for the part identified by part ID 405 based on the manufacturer's MTBF value 420. In one implementation, the initial keep level value may be obtained by applying a Spares Poisson Distribution (described with respect to Eqn. (1) below) to manufacturer's MTBF value 420, and may be expressed by a quantity Sᵢₙᵢₜᵢₐₗ (for N), where Sᵢₙᵢₜᵢₐₗ stands for the number of spares to be kept in stock and N stands for the number of parts used of a particular type. The initial keep level value (Sᵢₙᵢₜᵢₐₗ), therefore, indicates how many spare parts should be on-hand for a given quantity of a part currently installed (or in use) based on a value of the manufacturer's MTBF for the part. Actual keep level field 440 stores a value that defines a quantity of spare parts to keep for a certain quantity of parts installed for the part identified by part ID 405 based on actual MTBF value 425. In one implementation, the actual keep level value may be obtained by applying the Spares Poisson Distribution to actual MTBF value 425, and may be expressed by a quantity S_{actual} (for N), where S_{actual} stands for the number of spares to be kept in stock and N stands for the number of parts used of a particular type. The actual keep level value (S_{actual}), therefore, indicates how many spare parts should be on-hand for a given quantity of a part currently installed (or in use) based on a value of the actual MTBF for the part. Time stamp field 445 stores one or more time stamps associated with the installation of the part identified by part ID 405. The one or more time stamps stored in field 445 may be used in a historical analysis of the parts data to determine the part's actual MTBF value.

The number and content of the data fields of parts data DB 115 illustrated in FIG. 4 is for illustrative purposes. Other data structures, with more, fewer, or different data fields may be implemented. Therefore, parts data DB 115 may include additional, fewer and/or different data fields than those depicted in FIG. 4.

FIG. 5 is a diagram that depicts a data structure that may be stored in parts inventory DB 120. Parts inventory DB 120 may include multiple entries 500, with each entry 500 including an inventory location field 505, part ID field 405, an installed quantity field 515, an ordered quantity field 520, a spare quantity field 525, and a spares to add field 530.

Inventory location field 505 stores a unique identifier associated with the location where the part identified by part ID 405 may be obtained. The location may include a certain warehouse, the location of a certain supplier/vendor, or the actual installation site for the part. Other inventory locations may be identified in inventory location field 505.

Installed quantity field 515 stores a quantity of a part, identified by part ID 405 and obtained from inventory location 505, currently installed and in use. The quantity of parts stored in field 515 may be adjusted as parts fail, and are removed from service for replacement or repair, and as parts are obtained from inventory location 505 for installation in equipment and/or a system.

Ordered quantity field 520 stores a quantity of a part, identified by part ID 405 and obtained from inventory location 505, currently on order from a supplier/vendor and awaiting receipt. Spare quantity field 525 stores a quantity of a spare of a part, identified by part ID 405, that is currently available, and “in inventory,” at inventory location 505. Spares to add field 530 stores a quantity of a spare of a part, identified by part ID 405, that needs to be ordered for inventory location 505 to maintain an adequate supply of spare parts on-hand at inventory location 505.

The number and content of the data fields of parts inventory DB 120 illustrated in FIG. 5 is for illustrative purposes. Other data structures, with more, fewer, or different data fields may be implemented. Therefore, parts inventory DB 120 may include additional, fewer and/or different data fields than those depicted in FIG. 5.

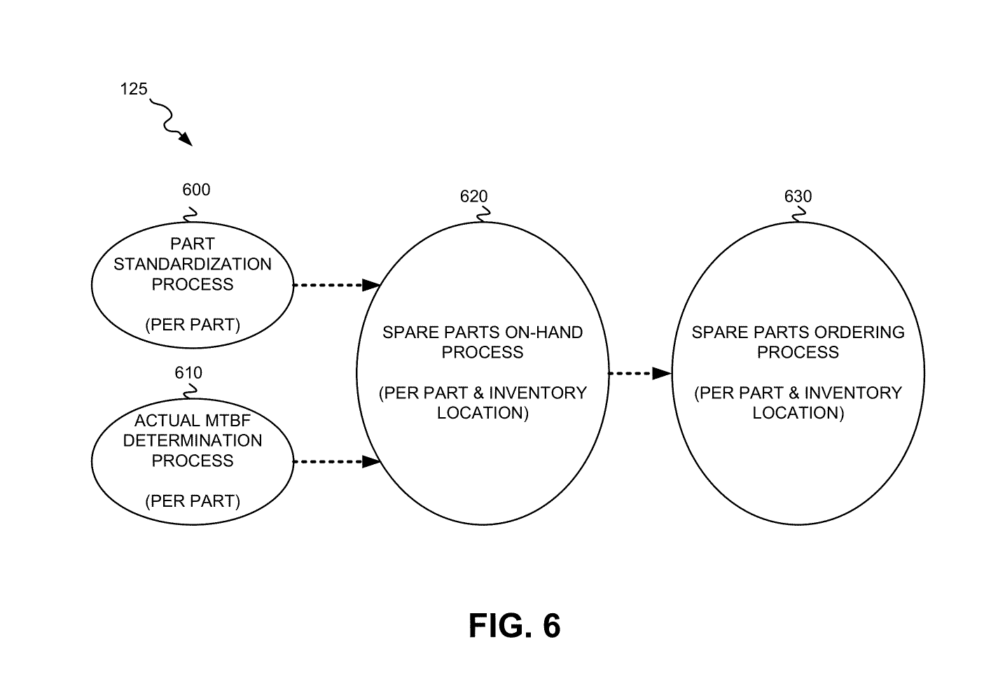

FIG. 6 is a diagram that depicts an exemplary spares on-hand procurement process 125 of FIG. 1. Spares on-hand procurement process 125 may include a part standardization process 600, an actual MTBF determination process 610, a spare parts on-hard process 620, and a spare parts ordering process 630.

Part standardization process 600 includes a process for standardizing each part needed for equipment, subsystem or system installation, maintenance or repair. The part standardization process may include defining each part's barcode, defining a risk factor (described above) for each part, and obtaining the manufacturer's MTBF, FIT and/or MTTR for each part. The part standardization process may further include determining a keep level value, which may be used for further determining a number of spares of the part to maintain on-hand at an inventory location, for each part, based on the manufacturer's MTBF. The data generated by the part standardization process 600 may be stored in parts data DB 115. Part standardization process 600 may be performed for each part maintained in inventory at an inventory location 105.

Actual MTBF determination process 610 includes a process for determining an actual MTBF, and a corresponding actual keep level value, based on observed, historical part failure data. Each observed failure of a given part in equipment, a system(s) or a subsystem(s) may be tracked and stored as historical data to allow the failure rate (i.e., number of failures during a certain period of time) to be determined. The actual MTBF for the part may be determined as the reciprocal of the determined failure rate for the part. Actual MTBF determination process 610 may further include determining an actual keep level value, which may be used in place of the initial keep level value determined in process 600, for determining a number of spares of the part to maintain on-hand at an inventory location, for each part based on the actual MTBF. Actual MTBF determination process 610 may be performed for each part maintained in inventory at an inventory location 105.

Spare parts on-hand process 620 includes a process for determining a quantity of spares of a part to be maintained on-hand at an inventory location 105. Process 620 may determine the quantity of spares of a part to be maintained on-hand based on data stored in parts data DB 115 and parts inventory DB 120 as a result of the performance of processes 600 and 610. Process 620 may use the initial keep level value generated in process 600, or the actual keep level value generated in process 610 to determine a nominal quantity of spares to be maintained at inventory location 105. Process 620 may determine a quantity spares to order using the quantity of spares currently stored at inventory location 105 and the determined nominal quantity of spares. Spare parts on-hand process 620 may be performed for each part and inventory location 105.

Spare parts ordering process 630 includes a process for ordering spare parts based on the spare part quantities determined in process 620. Process 630 may retrieve the quantity of spares to order determined in process 620, and may generate an order to the manufacturer or vendor of the part. Process 630 may manage the inventory of the spares on-hand based on the quantity of spares installed in equipment, subsystems or systems, and based on the receipt of spares ordered and received from the manufacturer or vendor.

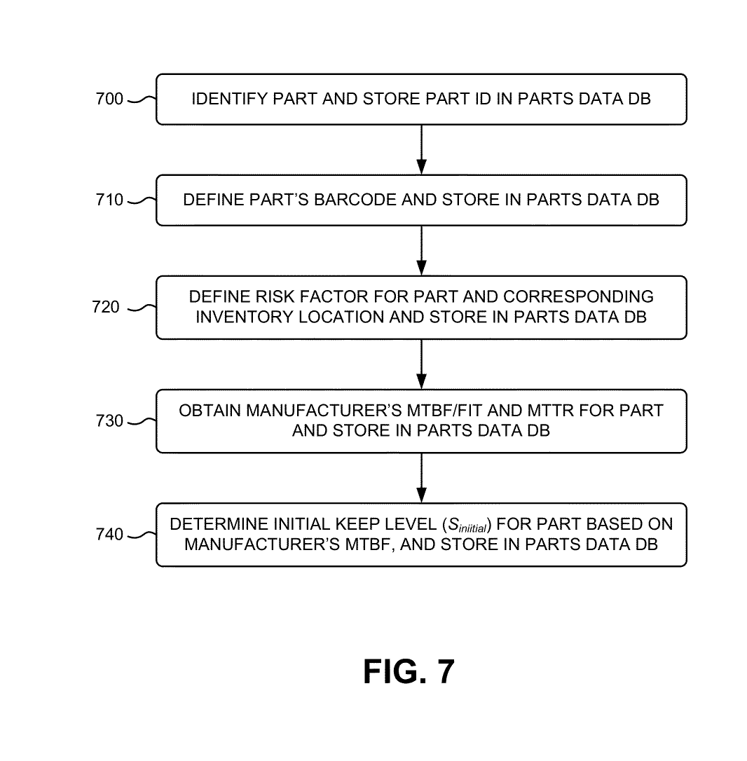

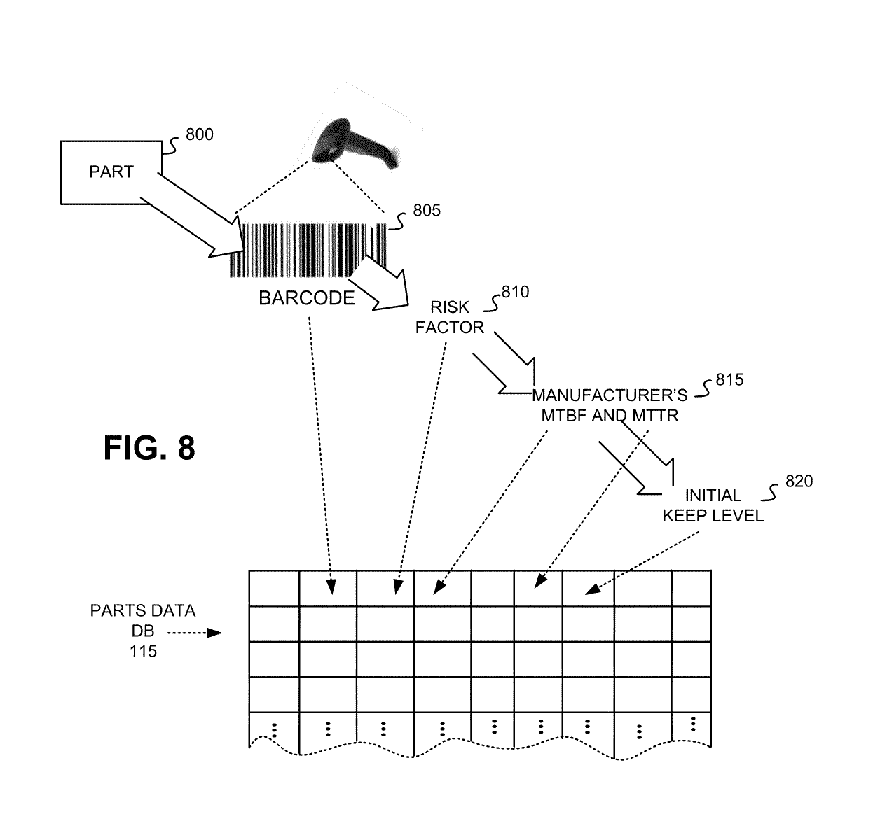

FIG. 7 is a flow diagram that illustrates part standardization process 600 of FIG. 6. The exemplary process of FIG. 7 may be implemented by inventory management device 100. The exemplary process of FIG. 7 is described below with reference to FIG. 8.

The exemplary process may include identifying a part and storing the part identifier in parts data DB 115 (block 700). Inventory management device 100 may identify a new part that is being standardized for entry into parts data DB 115. For example, an administrator may manually enter, or upload, the part's identifier into inventory management device 100. Inventory management device 100 may store the part identifier in part ID field 405 of parts data DB 115. Inventory management device 100 defines the part's barcode and stores the barcode information in parts data DB 115 (block 710). Inventory management device 100 may receive the part's barcode (e.g., via scanning the part's barcode with a barcode reader), and may store the barcode in parts data DB 115 (or a translation of the barcode). The administrator at inventory management device 100 may scan the new part's barcode, or personnel at IL device 220 may scan the new part's barcode and send the barcode information to inventory management device 100 via network 210. Inventory management device 100 may store the part's barcode information in part barcode field 410 of parts data DB 115. FIG. 8 depicts the barcode 805 of part 800 being scanned for the barcode data to be entered into parts data DB 115.

Inventory management device 100 defines a risk factor for the part, and a corresponding inventory location, and stores the risk factor in parts data DB 115 (block 720). Inventory management device 100 may define the risk factor for each part by considering the critical or non-critical nature of the part, the MTTR for the part, the manufacturer's MTBF for the part, and other factors. Based on these factors (and others), inventory management device 100 may specify a risk factor for each part that provides a measure of how quickly the part needs to be maintained to enable timely system/equipment installation, maintenance or repair. Inventory management device 100 may store the risk factor for the part in risk factor field 415 of parts data DB 115. FIG. 8 depicts a determined risk factor 810 being stored in parts data DB 115.

Inventory management device 100 obtains the manufacturer's MTBF/FIT and MTTR for the part and stores in parts data DB 115 (block 730). The administrator may manually enter the manufacturer's MTBF and/or FIT values and the MTTR value, or may upload them into inventory management device 100 from a data source. Inventory management device 100 may store the MTBF and/or FIT values in manufacturer's MTBF field 420 of parts data DB 115. Inventory management device 100 may store the manufacturer's MTTR value in manufacturer's MTTR field 430. FIG. 8 depicts the manufacturer's MTBF and MTTR values 815 being stored in parts data DB 115.

Inventory management device 100 determines the initial keep level (Sᵢₙᵢₜᵢₐₗ) for the part based on the manufacturer's MTBF, and stores the determined initial keep level (Sᵢₙᵢₜᵢₐₗ) in parts data DB 115 (block 740). For example, inventory management device 100 may apply the Spares Poisson Distribution formula (Eqn. (1) below) to the manufacturer's MTBF to calculate the initial keep level value (i.e., the initial number S of spare parts to carry in stock) based on the number of parts (N) used of a particular type:

$$P = {\sum }_{n = 0}^{S} [ \frac{{( N λ t )}^{n} {e}^{- N λ t }}{n !} ] \qquad Eqn . ( 1 )$$

where P is the probability of having a spare for a particular part available (i.e., in stock) when it is needed,

S is the number of spares carried in stock,

N is the number of parts used of a particular type,

λ is the part failure rate=1/MTBF, and

t is the time period of interest (i.e., the parts replenishment interval).

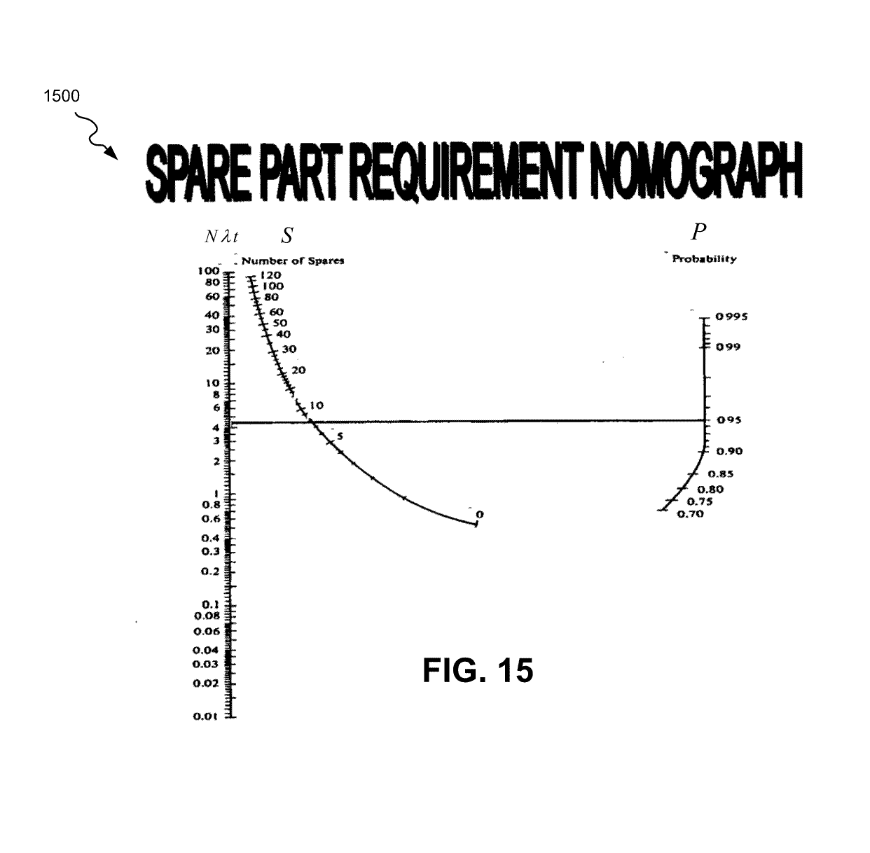

Eqn. (1) may be solved for the number of spares S to carry in stock using known values of N, MTBF and t to meet a chosen reliability requirement (e.g., a reliability requirement of P=95%). In one exemplary implementation, a Normal approximation to the Spares Poisson Distribution formula of Eqn. (1) may be used to solve for the number of spares S to carry in stock. In another exemplary implementation, the Spares Poisson Distribution Nomograph 1500 of FIG. 15 may be used to determine the number of spares S to carry in stock (i.e., to keep on hand) using the known values of N, MTBF and t. To use Nomograph 1500, the value of NAt is calculated from the known values of N, MTBF and t, and a desired probability P is chosen (i.e., a desired probability of having the part in stock). A straight line is then drawn on Nomograph 1500 from the NAt axis to the P axis, and the number of spares S that should be kept in stock is read off from where this line crosses the S axis. Inventory management device 100 may store the determined keep level value (Sᵢₙᵢₜᵢₐₗ) in initial keep level field 435 of parts data DB 115. FIG. 8 depicts the initial keep level value 820 being stored in parts data DB 115.

The exemplary process of FIG. 7 has been described as being implemented by inventory management device 100. However, in some implementations, the exemplary process of FIG. 7 may be implemented, at least in part, by, or in conjunction with, one or more inventory location devices 210.

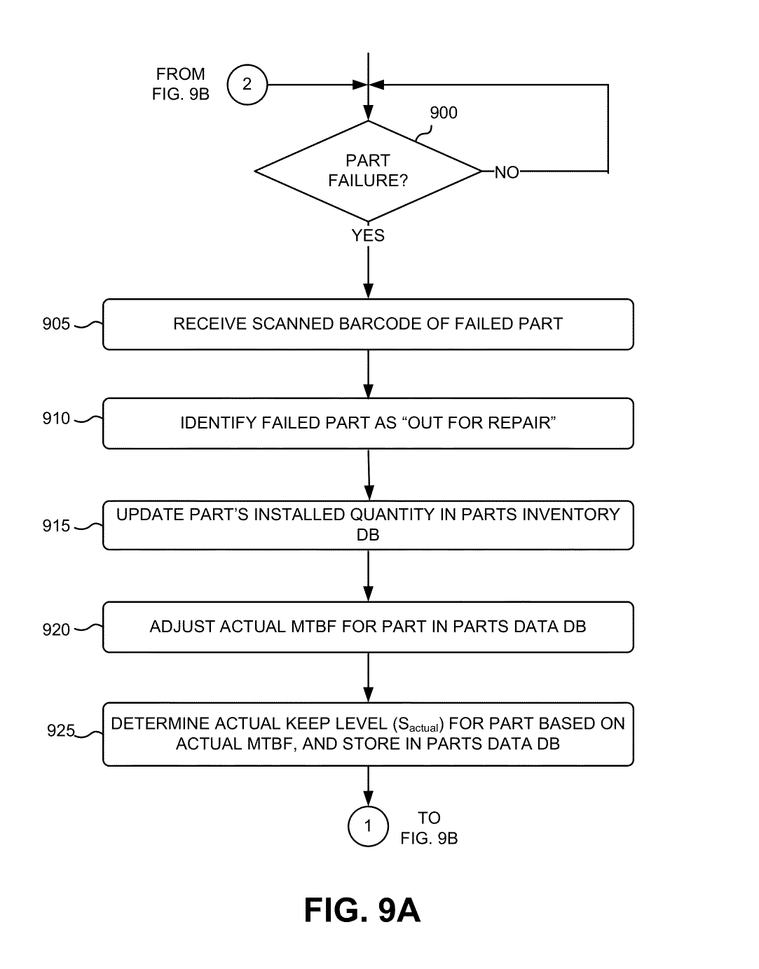

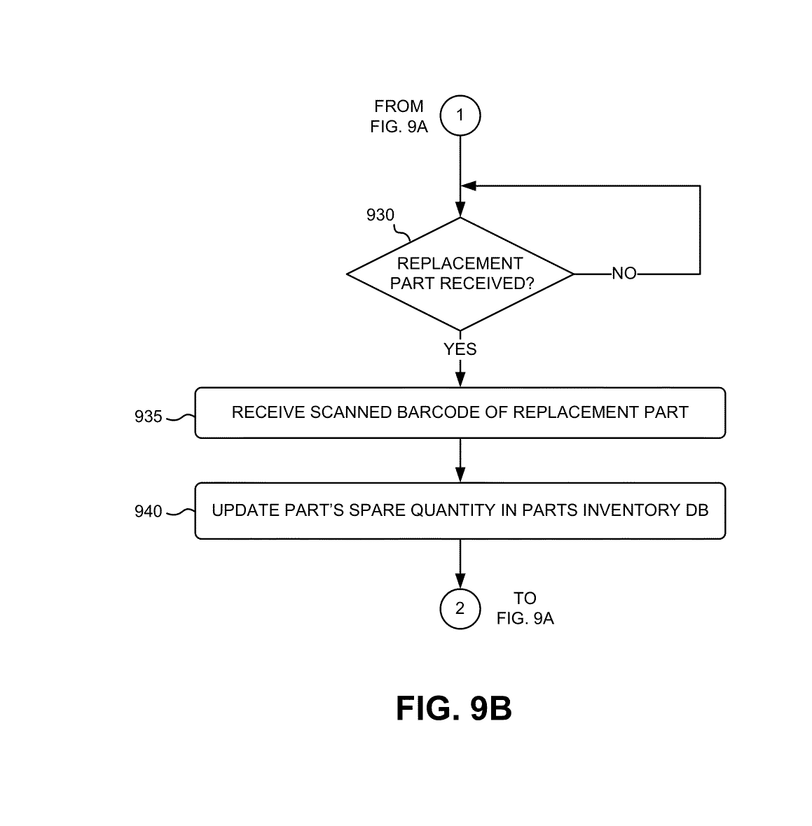

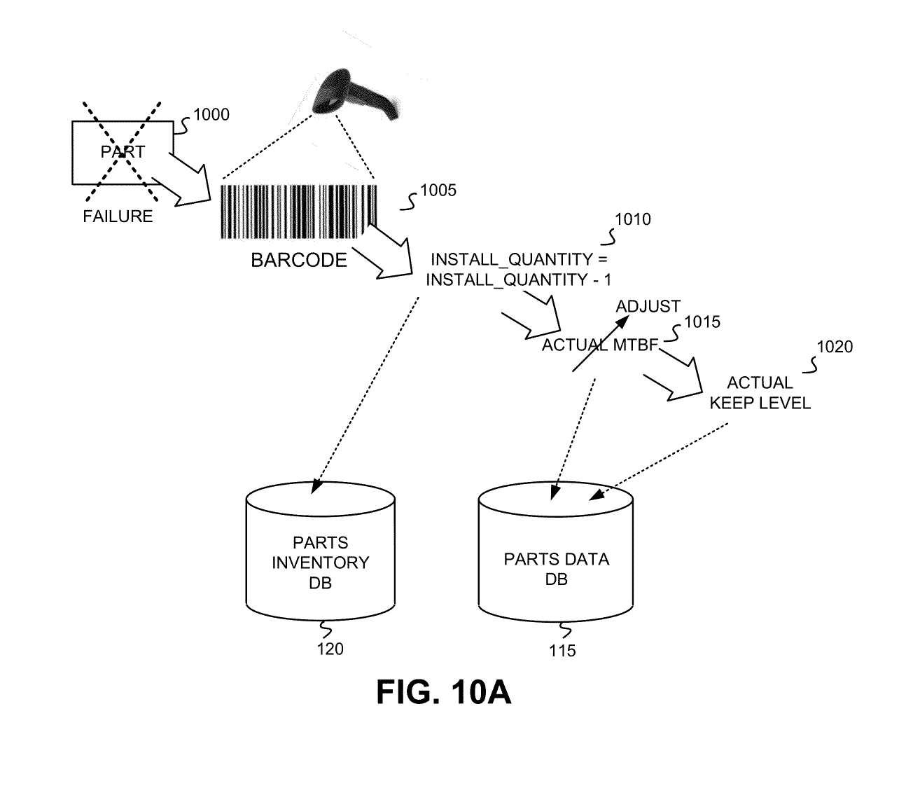

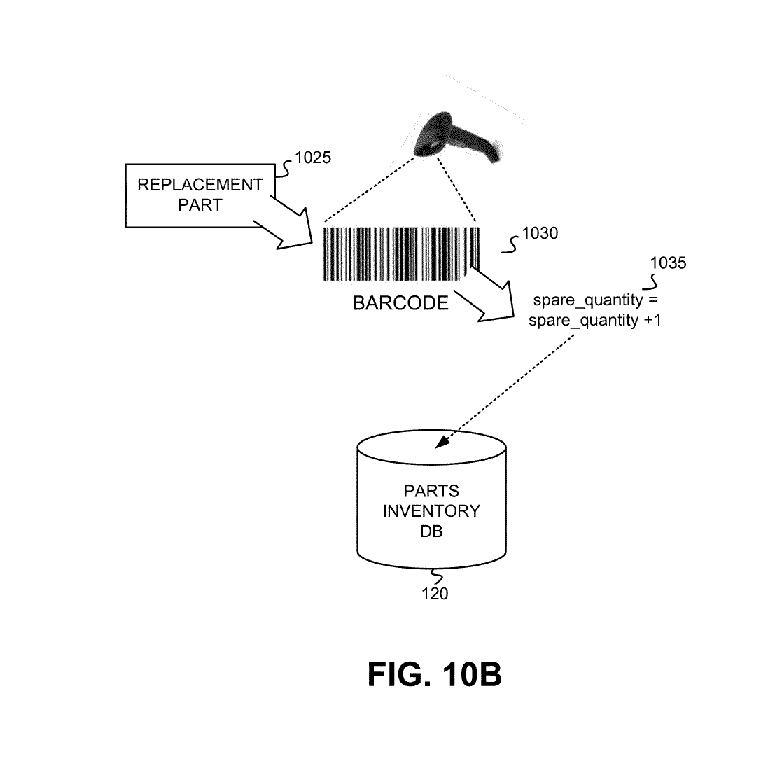

FIGS. 9A and 9B are flow diagrams that illustrate actual MTBF determination process 610 of FIG. 6. The exemplary process of FIGS. 9A and 9B may be implemented by inventory management device 100. The exemplary process of FIGS. 9A and 9B is described below with reference to FIGS. 10A and 10B.

The exemplary process may include inventory management device 100 determining if there has been a part failure (block 900). A part failure may be identified at any location where a given part has been installed. If there hasn't been a part failure (NO—block 900), then the exemplary process may wait for the occurrence of a part failure at block 900. If there has been a part failure (YES—block 900), then inventory management device 100 may receive the scanned barcode of the failed part (block 905). As shown in FIG. 10A, a part 1000 experiencing a failure may be scanned to obtain the barcode information 1005. The obtained barcode information may be sent to inventory management device 100 via network 210. Inventory management device 100 may identify the failed part as “out for repair” (block 910) and may update the part's “installed quantity” in parts inventory DB 120 (block 915). As shown in FIG. 10A, the failed part's installed quantity may be decremented (i.e., install_quantity−install_quantity−1) 1010, and the decremented value may be stored in installed quantity field 515 of parts inventory DB 120 that corresponds to the part ID 405 and inventory location 505 of the failed part.

Inventory management device 100 may update the actual MTBF for the part in parts data DB 115 (block 920). Based on historical failure data from the part, including the current failure of the part, inventory management device 100 may determine an updated value for the actual failure rate of the part. Device 100 may determine the updated value of the actual MTBF by taking the reciprocal of the updated actual failure rate. FIG. 10A depicts the adjustment 1015 of the actual MTBF value stored in parts data DB 115.

Inventory management device 100 may determine an actual keep level (S_{actual}) for the part based on the actual MTBF, and store the actual keep level in parts data DB 115 (block 925). The actual keep level (S_{actual}) may be determined as described above with respect to Eqn. (1), including possible use of the Spares Poisson Distribution Nomograph 1500 of FIG. 15, but using the actual MTBF instead of the manufacturer's MTBF. In some implementations, the MTTR may additionally be used in determining the actual keep level (S_{actual}). FIG. 10A depicts the determined actual keep level 1020 being stored in parts data DB 115. Referring to FIG. 9B, inventory management device 100 may determine if a replacement part has been received (block 930). If a replacement part has been received (YES—block 930), then inventory management device 100 may receive the scanned barcode of the replacement part (block 935). If the replacement part hasn't been received (NO—block 930), then the exemplary process may wait for receipt of the replacement part at block 930. As shown in FIG. 10B, a received replacement part 1025 may be scanned to obtain the barcode information 1030. The obtained barcode information may be sent to inventory management device 100 via network 210.

Inventory management device 100 may update the part's “spare quantity” in parts inventory DB 120 (block 940). As shown in FIG. 10B, the replacement part's spare quantity value (spare quantity) may be incremented (i.e., spare_quantity=spare_quantity+1) 1035, and the incremented value may be stored in spare quantity field 525 of an entry 500 of parts inventory DB 120 that corresponds to the part ID 405 and inventory location 505 of the replacement part.

The exemplary process of FIGS. 9A and 9B have been described as being implemented by inventory management device 100. However, in some implementations, the exemplary process of FIGS. 9A and 9B may be implemented, at least in part, by, or in conjunction with, one or more IL devices 220.

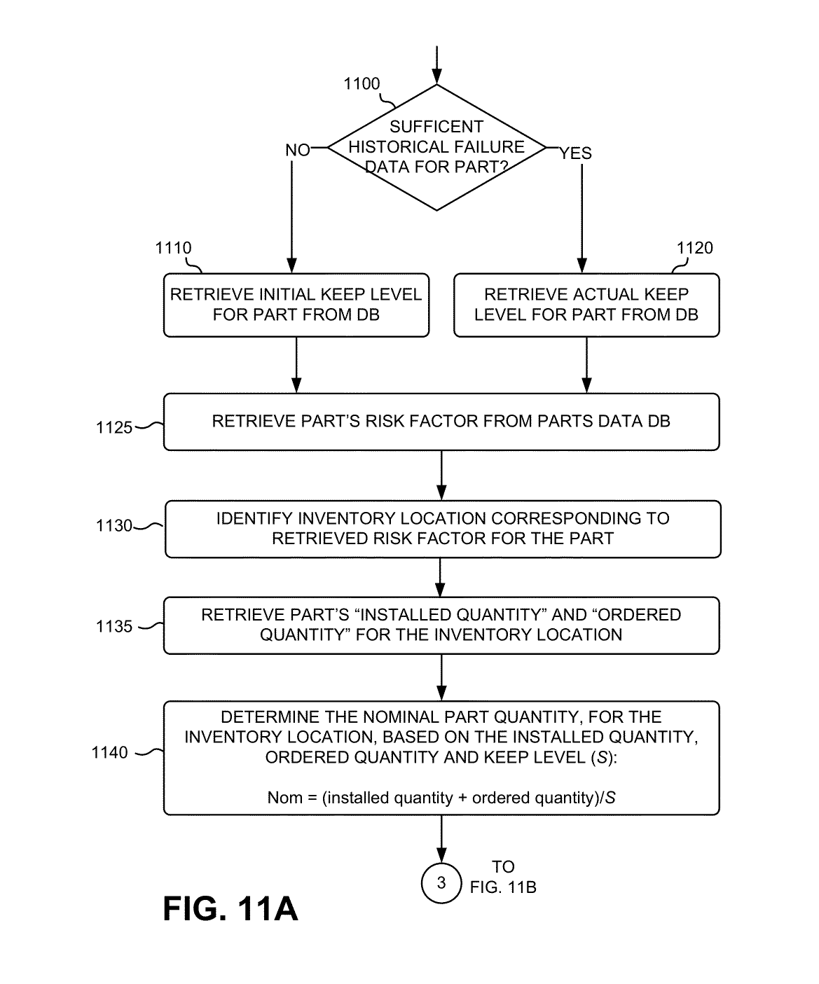

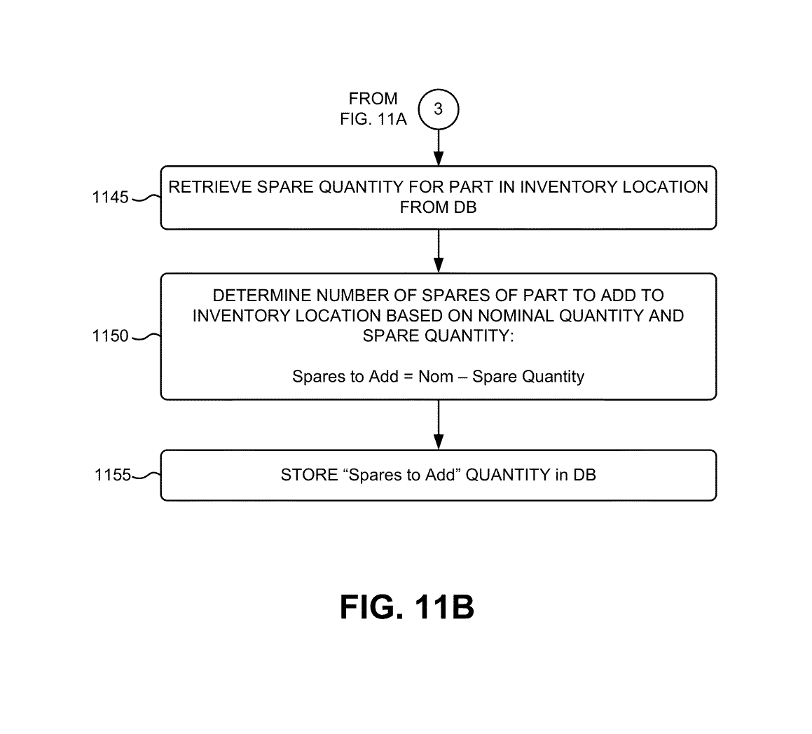

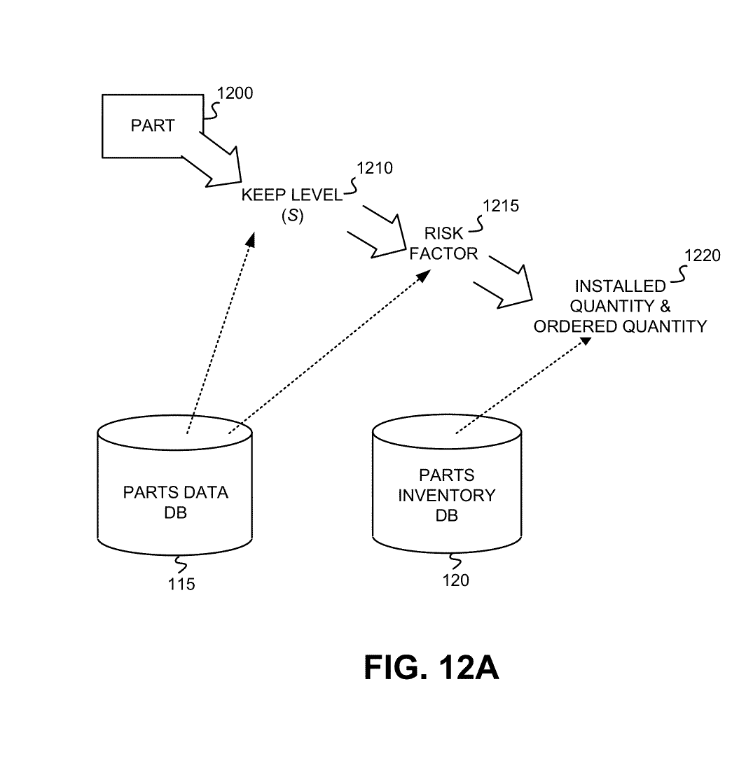

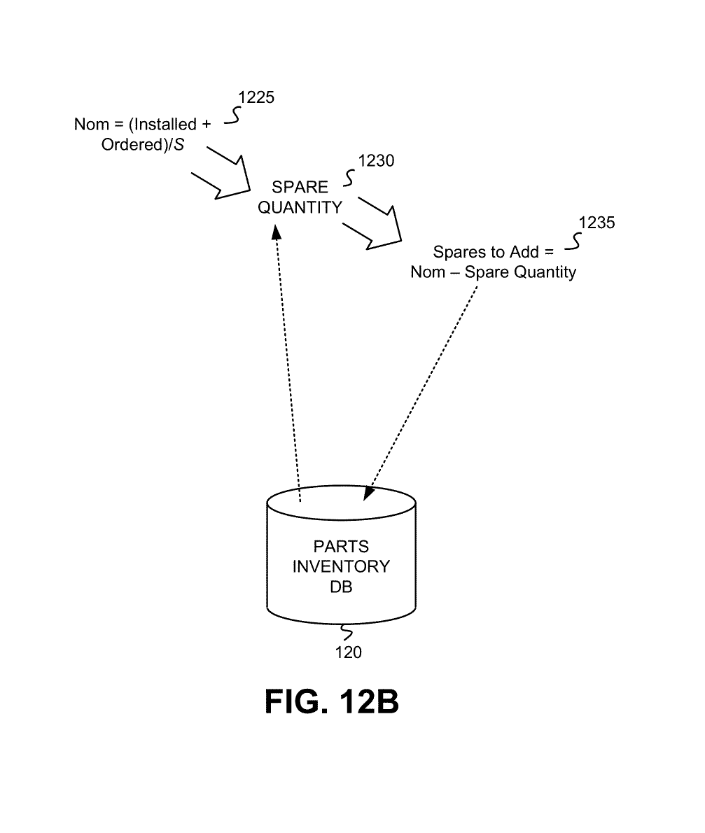

FIGS. 11A and 1 lB are flow diagrams that illustrate spare parts on-hand process 620 of FIG. 6. The exemplary process of FIGS. 11A and 11B may be implemented by inventory management device 100. The exemplary process of FIGS. 11A and 11B is described below with reference to FIGS. 12A and 12B. The exemplary process of FIGS. 11A and 11B may be selectively repeated for each part, having a part ID value stored in part ID field 405 of parts data DB 115. The exemplary process of FIGS. 11A and 11B may, therefore, be repeated for each part that is used in installing, repairing or maintaining equipment or a subsystem/system.

The exemplary process may include inventory management device 100 determining whether sufficient historical failure data exists for a part (block 1100). Failure data for each part may be accumulated for a period of time (e.g., six months) for use in calculating actual, observed failure rates for each part. If sufficient historical failure data does not exist for the part (NO—block 1100), then inventory management device 100 may retrieve an initial keep level for the part from parts data DB 115 (block 1110). Inventory management device 100 may index parts data DB 115 to locate an entry 400 whose part ID field 405 matches the part's ID value. Inventory management device 100 may retrieve the content of initial keep level field 435 from the located entry 400. Therefore, when sufficient historical, observed failure data for a part does not exist, then reliability data obtained from the manufacturer may be used for determining a quantity of spare parts to add to the inventory location.

If sufficient historical failure data does exist for the part (YES—block 1100), then inventory management device 100 may retrieve an actual keep level for the part from parts data DB 115 (block 1120). Inventory management device 100 may index parts data DB 115 to locate an entry 400 whose part ID field 405 matches the part's ID value. Inventory management device 100 may retrieve the content of actual keep level field 440 from the located entry 400. Therefore, when sufficient historical, observed failure data for a part does exist, then actual observed reliability data may be used for determining a quantity of spare parts to add to the inventory location. FIG. 12A depicts the keep level 1210 being retrieved from parts data DB 115 for part 1200.

Inventory management device 100 may retrieve the part's risk factor (block 1125). Inventory management device 100 may index parts data DB 115 to locate an entry 400 whose part ID field 405 matches the part's ID value. Inventory management device 100 may retrieve the content of risk factor field 415 from the located entry 400. FIG. 12A depicts the risk factor 1215 being retrieved from parts data DB 115 for part 1200.

Inventory management device 100 may identify an inventory location for the part that corresponds to the retrieved risk factor (block 1130). Each risk factor, which provides an indication of the critical or non-critical nature of a specific part, and how quickly the part needs to be obtained to enable timely system/equipment installation, maintenance or repair, may be equated to a corresponding inventory location 105, whose proximity to the installation, repair or maintenance site directly relates to the part's risk factor. As an example, if a part has a risk factor of one, indicating a highly critical part, then the inventory location may reside at the actual installation, repair or maintenance site to minimize the amount of time required to obtain the part from inventory. As another example, if a part has a risk factor of two, indicating a moderately critical part, then the inventory location may reside at a warehouse in relatively close proximity to the installation, repair or maintenance site. As a further example, if a part has a risk factor of three, indicating a moderately non-critical part, then the inventory location may reside at a warehouse that is farther away from the installation, repair or maintenance site than a warehouse corresponding to a risk factor of two. As an additional example, if a part has a risk factor of four, indicating a non-critical part, then the inventory location may reside at the part manufacturer's or vendor's warehouse.

Inventory management device 100 may retrieve the part's “installed quantity” and “ordered quantity” for the inventory location from parts inventory DB 120 (block 1135). Inventory management device 100 may index parts inventory DB 120 to locate an entry 500 whose part ID field 405 matches the part's ID value and whose inventory location field 505 matches the identified inventory location. Inventory management device 100 may retrieve the content of installed quantity field 515 and ordered quantity field 520 from the located entry 500. FIG. 12A depicts the installed quantity and ordered quantity 1220 being retrieved from parts inventory DB 120.

Inventory management device 100 may determine a nominal part quantity (Nom), for the inventory location, based on the “installed quantity,” the “ordered quantity,” and the keep level (block 1140). In one implementation, as shown in FIG. 12B, inventory management device 100 may determine the nominal part quantity (Nom) 1225 based on the following equation:

Nom=(installed quantity+ordered quantity)/S, where S represents the keep level.

Inventory management device 100 may retrieve a “spare quantity” for the part in the inventory location from parts inventory DB 120 (block 1145). Inventory management device 100 may index parts inventory DB 120 to locate an entry 500 whose part ID field 405 matches the part's ID value and whose inventory location field 505 matches the identified inventory location. Inventory management device 100 may retrieve the content of spare quantity field 525 from the located entry 500. FIG. 12B depicts the spare quantity 1230 being retrieved from parts inventory DB 120.

Inventory management device 100 may determine a number of spares of the part to add to the inventory location based on the nominal part quantity and the spare quantity (block 1150). In one implementation, as shown in FIG. 12B, inventory management device 100 may determine the quantity of spares 1235 of the part to add to the inventory location based on the equation:

Spares to Add=Nom−Spare Quantity

Inventory management device 100 may store the determined “spares to add” quantity in parts inventory DB 120 (block 1155). Inventory management device 100 may index parts inventory DB 120 to locate an entry 500 whose part ID field 405 matches the part's ID value and whose inventory location field 505 matches the identified inventory location. Inventory management device 100 may store the determined “spares to add” quantity in spares to add field 530 of the located entry 500. FIG. 12B depicts the “spares to add” quantity 1235 being stored in parts inventory DB 120. The stored “spares to add” quantity may subsequently be used for ordering spares of the part.

The exemplary process of FIGS. 11A and 11B have been described as being implemented by inventory management device 100. However, in some implementations, the exemplary process of FIGS. 11A and 11B may be implemented, at least in part, by, or in conjunction with, one or more inventory location devices 210.

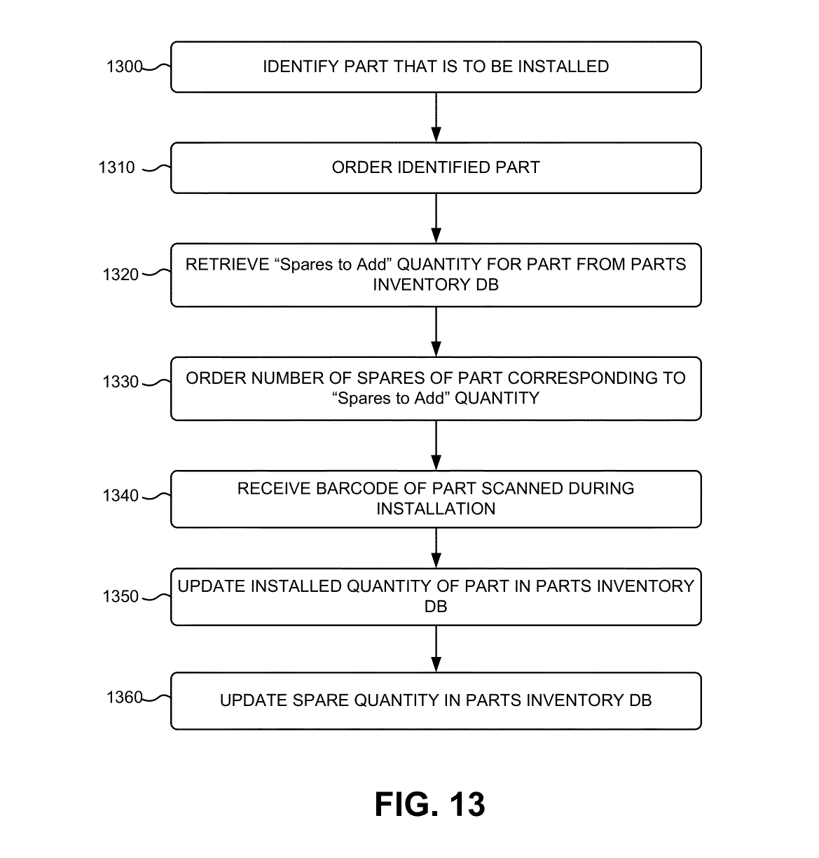

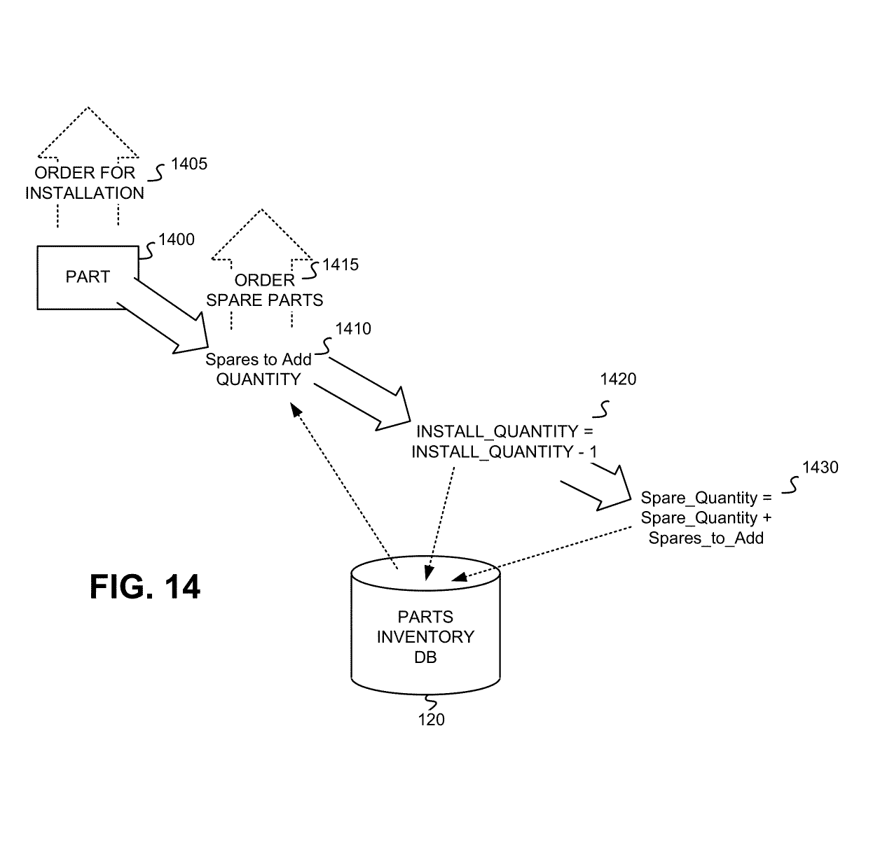

FIG. 13 is a flow diagram that illustrates spare parts ordering process 630 of FIG. 6. The exemplary process of FIG. 13 may be implemented by inventory management device 100. The exemplary process of FIG. 13 is described below with reference to FIG. 14.

The exemplary process may include identifying the part that is to be installed (block 1300). A part may be identified for installation in equipment, a subsystem(s) or a system(s) based on a failure of the equipment, subsystem(s), or system(s), or based on a maintenance schedule associated with the equipment, subsystem(s) or system(s). Inventory management device 100 may order the identified part (block 1310). Inventory management device 100 may generate an order from the manufacturer of the part, or from a vendor that sells the part. FIG. 14 depicts part 1400 being ordered 1405 for installation in equipment, a subsystem(s) or system(s).

Inventory management device 100 may retrieve a “spares to add” quantity for the part from parts inventory DB 120 (block 1320). Inventory management device 100 may index parts inventory DB 120 to locate an entry 500 whose part ID field 405 matches the part's ID value. Inventory management device 100 may retrieve the “spares to add” quantity stored in spares to add field 530 from the located entry 500. FIG. 14 depicts the “spares to add” quantity 1410 being retrieved from parts inventory DB 120. Inventory management device 100 may order a number of spares of the part corresponding to the “spares to add” quantity (block 1330). Inventory management device 100 may generate an order from the manufacturer of the part, or from a vendor that sells the part, with the ordered quantity including the “spares to add” quantity retrieved from field 530 of entry 500 of parts inventory DB 120. FIG. 14 depicts spare parts of part 1400 being ordered 1415 for storing in an inventory location 105.

Inventory management device 100 may receive the barcode of the part that was scanned during installation of the part (block 1340), and inventory management device 100 may update the “installed quantity” of the part in parts inventory DB 120 (block 1350). Personnel at the inventory location 105 may scan the replacement part obtained from inventory location 105, and device 100 may index parts inventory DB 120 to locate an entry 500 whose part ID field 405 matches the received replacement part's ID value. Inventory management device 100 may decrement the “installed quantity” value (i.e., install_quantity=install_quantity−1) stored in installed quantity field 515 of the located entry to reflect that a part has been removed from the inventory location 105 and installed in the equipment, subsystem, or system. FIG. 14 depicts the install quantity being decremented 1420, and storing the decremented value in parts inventory DB 120.

Inventory management device 100 may update the “spare quantity” in parts inventory DB 120 (block 1360). When the spare parts ordered in block 1330 are received from the manufacturer or vendor, device 100 may index parts inventory DB 120 to locate an entry 500 whose part ID field 405 matches the ID value of the spare parts received from the manufacturer or vendor. Inventory management device 100 may increment the value stored in spare quantity field 525 of the located entry with the “spares to add” quantity received from the manufacturer or vendor (and ordered in block 1330). FIG. 14 depicts the spare quantity value being incremented 1430 by a quantity that corresponds to the ordered quantity received from the manufacturer or vendor, and storing the incremented “spare quantity” value in parts inventory DB 120. Updating the “spare quantity” value in parts inventory DB 120, thus, maintains an accurate, up-to-date inventory of quantities of spares of a given part that are stored on-hand at a given inventor location 105.

The exemplary process of FIG. 13 has been described as being implemented by inventory management device 100. However, in some implementations, the exemplary process of FIG. 13 may be implemented, at least in part, by, or in conjunction with, one or more inventory location devices 210.

The foregoing description of implementations provides illustration and description, but is not intended to be exhaustive or to limit the invention to the precise form disclosed. Modifications and variations are possible in light of the above teachings or may be acquired from practice of the invention. For example, while series of blocks have been described with respect to FIGS. 7, 9A, 9B, 11A, 11B, and 13, the order of the blocks may be varied in other implementations. Moreover, non-dependent blocks may be performed in parallel.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A computer-readable medium containing instructions executable by at least one processor, the computer-readable medium comprising:
one or more instructions for obtaining a value associated with a failure rate of a part;
one or more instructions for determining a keep level value associated with the part based on the value associated with the failure rate, wherein the keep level value indicates how many spare parts should be on hand for a given quantity of parts currently installed;
one or more instructions for obtaining a risk factor for the part, wherein the risk factor corresponds to a time period required for the part to be replaced when the part fails;
one or more instructions for identifying an inventory location for the part based on the part's risk factor, wherein the inventory location is where spares of the part are stored;
one or more instructions for obtaining a currently installed quantity and an ordered quantity for the part at the identified inventory location;
one or more instructions for determining a part quantity for the part and the inventory location based on the installed quantity, the ordered quantity, and the keep level value; and
one or more instructions for determining the number of spares to add to the inventory location based on the part quantity and a current spare quantity of the part stored at the inventory location.

2. The computer-readable medium of claim 1, wherein the one or more instructions for obtaining the value associated with the failure rate of the part further comprise:
one or more instructions for obtaining a Mean Time Between Failure (MTBF) value for the part based on the failure rate.

3. The computer-readable medium of claim 2, wherein the MTBF value for the part is obtained from manufacturer's data.

4. The computer-readable medium of claim 2, wherein the one or more instructions for determining the keep level value associated with the part further comprise:
one or more instructions for determining the keep level value based on the MTBF value.

5. The computer-readable medium of claim 1, wherein the one or more instructions for obtaining the value associated with the failure rate of the part further comprise:
one or more instructions for determining whether sufficient historical failure data exists for the part;
one or more instructions for obtaining manufacturer supplied failure rate data for the part if sufficient historical failure data does not exist; and
one or more instructions for determining the value associated with the failure rate of the part based on the historical failure data.

6. The computer-readable medium of claim 1, wherein the one or more instructions for determining the keep level value comprise one or more instructions for using a Poisson Distribution formula to determine the keep level value.

7. The computer-readable medium of claim 1, wherein the risk factor provides an indication of the critical or non-critical nature of the part and how quickly the part needs to be obtained to enable system or equipment installation, maintenance or repair within a particular time period.

8. An inventory management device, comprising:
a communication interface coupled to a network;
a processing unit configured to:
define risk factors for multiple parts, wherein each of the risk factors correspond to a time required for a failed one of the multiple parts to be replaced,
determine reliability data associated with the multiple parts, and
determine a number of spares of each of the multiple parts to add to each of multiple inventory locations based on the multiple parts' reliability data and defined risk factors.

9. The device of claim 8, wherein the processing unit is further configured to:
order, via the communication interface, the determined number of spares of each of the multiple parts to add to each of the multiple inventory locations.

10. The device of claim 8, wherein the risk factors for the multiple parts provide an indication of the critical or non-critical nature of the multiple parts and how quickly each of the multiple parts needs to be obtained to enable timely system or equipment installation, maintenance or repair within a particular time period.

11. The device of claim 8, wherein the reliability data comprises actual failure rates associated with the multiple parts while installed in equipment, subsystems, or systems.

12. The device of claim 8, wherein the reliability data comprises mean-time-between failure (MTBF) values obtained from the part's manufacturers or vendors.

13. The device of claim 11, wherein the actual failure rates associated with the multiple parts comprise a total number of failures for each of the multiple parts over a period of time.

14. The device of claim 11, wherein the processing unit is further configured to:
determine mean-time-between failure (MTBF) values for each of the multiple parts by taking a reciprocal of each of the determined actual failure rates.

15. The device of claim 14, wherein, when determining the number of spares of each of the multiple parts, the processing unit further configured to:
determine the number of spares of each of the multiple parts to add to each of the multiple inventory locations based on each of the multiple parts' MTBF values and the defined risk factors.

16. The device of claim 14, wherein the processing unit is further configured to:
determine a spare part keep level value for each of the multiple parts based on the MTBF values.

17. The device of claim 16, wherein, when determining the spare keep level for each of the multiple parts, the processing unit is further configured to:
apply a Poisson distribution formula to the MTBF values for each of the multiple parts to determine the spare keep level value.

18. The device of claim 16, wherein the processing unit is further configured to:
obtain a number of each of the parts that is currently installed, and a number of each of the parts that is currently on order,
wherein, when determining the number of spares of each of the multiple parts to add to each of the multiple inventory locations, the processing unit is further configured to:
determine the number of spares of each of the multiple parts to add to each of the multiple inventory locations based on the number of each of the parts that is currently installed, the number of each of the parts that is currently on order, and the determined spare part keep level value.

19. A method, comprising:
defining, by an inventory management device, risk factors for multiple parts, wherein the risk factors for the multiple parts provide an indication of the critical or non-critical nature of the multiple parts and how quickly each of the multiple parts needs to be obtained to enable timely system or equipment installation, maintenance or repair;
determining, by the inventory management device, reliability data associated with the multiple parts, wherein the reliability data comprises mean-time-between failure (MTBF) values obtained from the part's manufacturers or vendors, or from observed, historical part failures;
determining, by the inventory management device, a number of spares of each of the multiple parts to add to each of multiple inventory locations based on the multiple parts' reliability data and defined risk factors; and
ordering, via a communication interface of the inventory management device, the determined number of spares of each of the multiple parts to add to each of the multiple inventory locations.

20. The method of claim 19, wherein determining the number of spares of each of the multiple parts further comprises:
determining the number of spares of each of the multiple parts to add to each of the multiple inventory locations based on each of the multiple parts' MTBF values and the defined risk factors.

21. The method of claim 19, further comprising:
determining a spare part keep level value for each of the multiple parts based on the MTBF values.

22. The method of claim 21, wherein determining the spare keep level value for each of the multiple parts further comprises:
applying a Poisson distribution formula to the MTBF values for each of the multiple parts to determine the spare keep level value.

23. The device of claim 21, further comprising:
obtaining a number of each of the parts that is currently installed, and a number of each of the parts that is currently on order, and
wherein determining the number of spares of each of the multiple parts to add to each of the multiple inventory locations further comprises:
determining the number of spares of each of the multiple parts to add to each of the multiple inventory locations based on the number of each of the parts that is currently installed, the number of each of the parts that is currently on order, and the determined spare part keep level value.
